(19) United States
(12) Patent Application Publication
(10) Pub. No.: US 2014/0070028 A1
(43) Pub. Date: Mar. 13, 2014

(54) Pressure Regulator for a Diesel Fuel Injection System

(71) Applicants: Pierre-Marie Rochas, Villeurbanne (FR); Alain Amblard, Genas (FR); Jean-Roch Julien, Corbas (FR)

(72) Inventors: Pierre-Marie Rochas, Villeurbanne (FR); Alain Amblard, Genas (FR); Jean-Roch Julien, Corbas (FR)

(73) Assignee: Robert Bosch GmbH, Stuttgart (DE)

(21) Appl. No.: 14/006,814

(22) PCT Filed: Feb. 15, 2012
(86) PCT No.: PCT/EP2012/052593

§ 371 Date: Nov. 27, 2013

(30) Foreign Application Priority Data
Mar. 25, 2011 (FR) 11/00900
Dec. 12, 2011 (FR) 1161438

(51) Int. Cl. F02M 63/00

(52) U.S. Cl. CPC F02M 63/0073
USPC 239/533.3

(57) ABSTRACT

A pressure regulator for a diesel fuel injection system includes an inlet configured to be connected to a reservoir of the diesel fuel injection system of a diesel engine, an outlet configured to be connected to a low-pressure group, a controllable closing device configured to be driven by an actuator between a first state in which the inlet and the outlet are hermetically isolated and a second state in which the inlet is connected to the outlet, and a plurality of spaces arranged on a side of the closing device including the outlet. A pressure compensation duct is configured to connect at least two spaces of the plurality of spaces to each other.

The present invention relates essentially to a pressure regulator for a diesel injection system.

A diesel engine of known type for a motor vehicle (typically a motor vehicle of less than 3.5×106 g) typically contains a plurality of cylinders, wherein each cylinder is provided with a high-pressure injection valve which ensures injection of the diesel fuel by way of electric activation, it being possible for the pressure to reach or exceed 2.5 108 Pa. Each injection valve has an injection chamber which is connected continuously, on the one hand, to a high-pressure reservoir referred to as a common rail and, on the other hand, to an injection opening connected to the cylinder to be supplied. An injection needle situated in the pressure chamber is driven by an electric actuator, e.g. a coil/magnet, an electromagnet or a piezoelectric actuator, between a first injection position, in which the pressure chamber is connected to the injection opening, and a second position, in which the needle closes the passage between the pressure chamber and the injection opening. A pressure regulator of known type has a discharge nozzle leading to the fuel tank under atmospheric pressure or under a higher pressure, the opening of which nozzle when there is excess pressure in the pressure reservoir is brought about in accordance with control by a computer by an electric actuator which moves a rod, one end of which effects the hermetic closure of the nozzle by means of a ball.

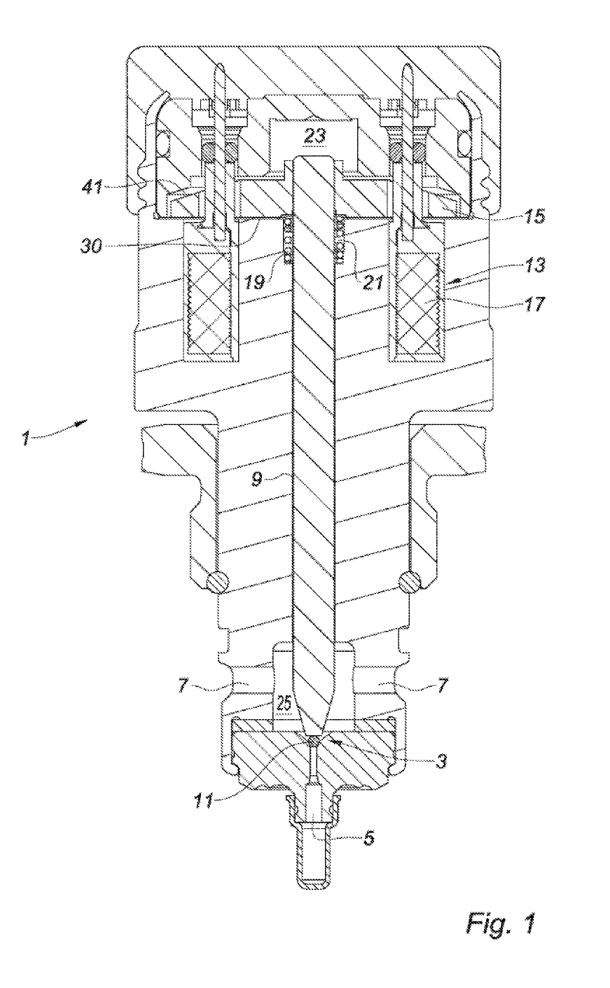

The rod is guided in a rectilinear translatory motion between a first, hermetically closed position (lower position in FIGS. 1, 2, 3, 4, 6, 8, 10, 11, 12, 13, 14, 16, 21, 22, 23 and 24) and a second, open position (upper position in the abovementioned figures). Guidance is provided in a known manner by a cylindrical bore machined into the regulator body of known type. A functional clearance, which has proven to be small, typically measuring between 19 and 37 μm, is maintained between the inside diameter of the guide bore and the outside diameter of the closing rod.

On the other hand, various volumes are machined into the interior of the pressure regulator of known type, such as the actuator chamber, the chamber for a return spring that pushes the rod into the open position, and the relief chamber situated at the nozzle. During operation, the individual chambers and the functional clearance between the bore and the rod are partially filled with diesel fuel for most of the time, the fuel being brought in equilibrium to a pressure approximately equal to the motor vehicle tank pressure prevailing in the fuel tank or to a low pressure, e.g. less than or equal to 1.2×10⁶ Pa. On the one hand, a pressure regulator of known type can exhibit uncontrolled movements of the rod and, on the other hand, can cause noise, which is detrimental to comfort in the motor vehicle fitted with such a pressure regulator.

The applicant has discovered that the cause of these phenomena lies in pressure differences between the individual cavities in the pressure regulator, brought about, in particular, by pressure waves in the low-pressure circuit, especially during the transients such as engine starting and stopping. The functional guide clearance between the bore and the rod is not sufficient to ensure rapid pressure compensation.

Consequently, it is an object of the present invention to make available a pressure regulator in which the low-pressure part is compensated.

It is also an object of the present invention to make available a pressure regulator in which the position of the rod is determined by the signal output to the electric actuator, with consideration being given to return springs, if appropriate. In other words, it is also an object of the present invention to avoid the rod being driven by the fuel pressure differences which arise at the various points around the rod (low pressure zones of the pressure regulator and, in particular, the chamber of the electric actuator, the spring chamber, the clearance between the guide bore and the rod and/or the relief chamber).

It is likewise an object of the present invention to make available a diesel engine in which the injection pressure is highly uniform, in which surges are avoided and in which running is smooth and uniform, even in the case of changes in engine speed and during starting.

It is likewise an object of the present invention to make available a diesel engine in which operating noise is moderate and, in particular, in which the noise produced by the pressure regulator is negligible.

It is likewise an object of the present invention to make available a motor vehicle, in the passenger cell of which the operating noise of the diesel engine is negligible.

According to the invention, these objects are achieved by the fact that at least one connecting duct is machined in between a point in the hydraulic circuit which has been brought to a reference pressure, typically atmospheric pressure, and the various points in the pressure regulator which might be brought to pressures that differed from the reference pressure in the absence of said duct. The reference pressure is, for example, that prevailing in the diesel fuel tank, the pressure in the relief chamber and/or the pressure at the inlet to the diesel fuel filter supplying the high-pressure pump. As explained below, various embodiments of the pressure regulator according to the invention are provided with internal and/or external ducts which connect the most significant points in the low-pressure part of the pressure regulator.

The invention relates primarily to a pressure regulator having an inlet, which can be connected to a reservoir of a diesel fuel injection system for a diesel engine, an outlet, which can be connected to a low-pressure unit, controllable closing means, which can be driven by an actuator between a first state, in which the inlet and the outlet are hermetically isolated, and a second state, in which the inlet is connected to the outlet, a plurality of volumes arranged on the side of the closing means provided with the outlet, characterized in that it has a compensation duct which connects at least two of the abovementioned volumes.

The invention likewise relates to a pressure regulator, characterized in that the closing means have a nozzle, and in that a first of the abovementioned volumes is a relief chamber arranged between the abovementioned nozzle and the abovementioned outlet.

The invention furthermore relates to a pressure regulator, characterized in that the actuator which controls the closing means is an electric actuator having a magnetic hub, and in that a second of the abovementioned volumes is a chamber of the magnetic hub.

The invention likewise relates to a pressure regulator, characterized in that it has a return spring for the closing means, and in that a third of the abovementioned volumes is a spring chamber.

The invention likewise relates to a pressure regulator, characterized in that the abovementioned duct has a line which is situated outside a body of the abovementioned pressure regulator, of which a first end is connected to a pressure regulator outlet and of which a second end is connected to the chamber of the magnetic core.

The invention likewise relates to a pressure regulator, characterized in that the closing means have a rod, and in that the duct is machined into said rod.

The invention likewise relates to a pressure regulator, characterized in that the rod has a substantially cylindrical shape with a longitudinal axis, and in that the duct has an axial section machined into the interior of the rod body, along the abovementioned rod axis.

The invention likewise relates to a pressure regulator, characterized in that the abovementioned duct has a radial section which is connected to the axial section and opens into one of the abovementioned volumes.

The invention likewise relates to a pressure regulator, characterized in that the duct comprises a recess formed by removing material from the surface of the abovementioned rod.

The invention likewise relates to a pressure regulator, characterized in that it has a section machined into a body of said pressure regulator.

The invention likewise relates to a pressure regulator, characterized in that it has a sleeve provided with a duct, wherein a first end of the duct is connected to the line, and a second end remote from the abovementioned first end opens into the chamber of the magnet core.

The invention likewise relates to a pressure regulator, characterized in that the magnet armature has an axial precision bore to accommodate the sleeve.

The invention likewise relates to a pressure regulator, characterized in that the abovementioned duct has branches which connect three of the abovementioned volumes to one another.

The invention likewise relates to a pressure regulator, characterized in that the outlet can be connected to a line connected to a diesel fuel tank.

The invention likewise relates to a pressure regulator, characterized in that the outlet can be connected to a line which is connected to an inlet of a supply filter for a high-pressure diesel fuel pump.

The invention also relates to a high-pressure diesel fuel injection system in a diesel engine, characterized in that it has a pressure regulator according to the invention.

The invention also relates to a diesel engine, characterized in that it has an injection system according to the invention.

The invention also relates to a motor vehicle, characterized in that it has an engine according to the invention.

The invention also relates to a pressure regulator, characterized in that one end of the line opens into the outlet.

The invention also relates to a pressure regulator, characterized in that the body has an isolating wall for the line with respect to the spring chamber.

The invention also relates to a pressure regulator, characterized in that the magnet armature has a precision bore, the diameter of which is greater than the diameter of the line.

The invention also relates to a pressure regulator, characterized in that a first end of the precision bore opens opposite the line and a second end of the precision bore opens into a lift volume of the magnetic core.

The invention is explained by means of the following description and of the attached figures, in which:

FIG. 1 is an axial section through a pressure regulator of known type;

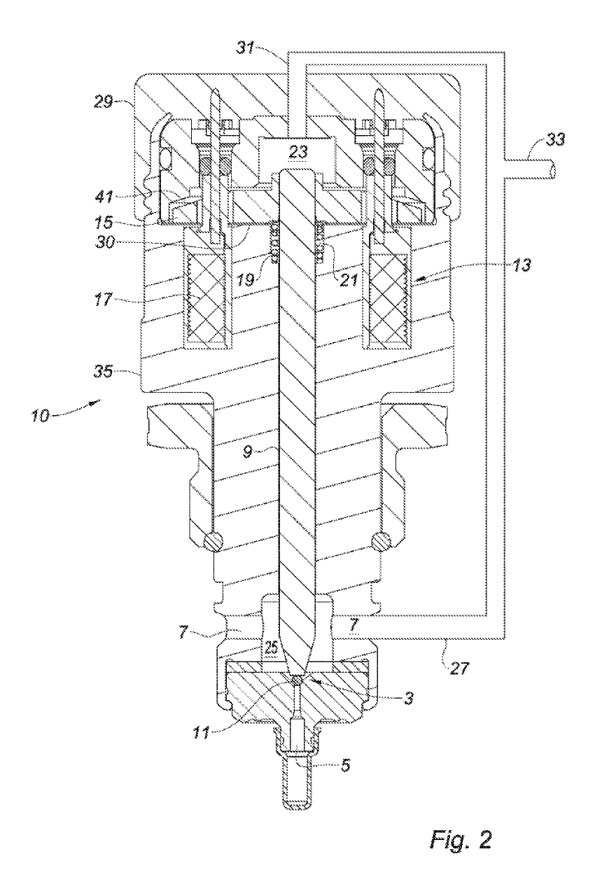

FIG. 2 is an axial section through a first illustrative embodiment of an actuator according to the invention;

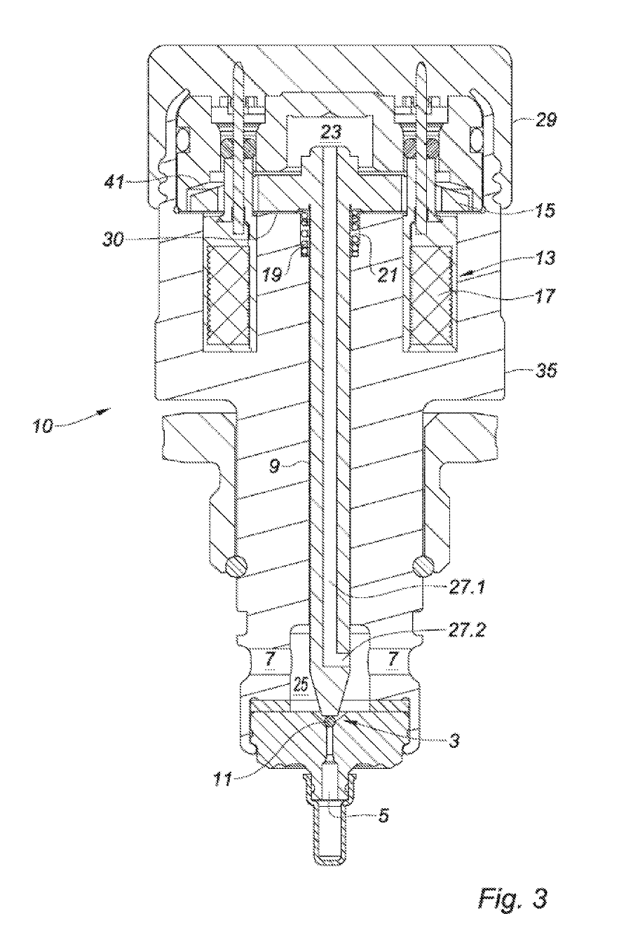

FIG. 3 is an axial section through a second illustrative embodiment of a pressure regulator according to the invention;

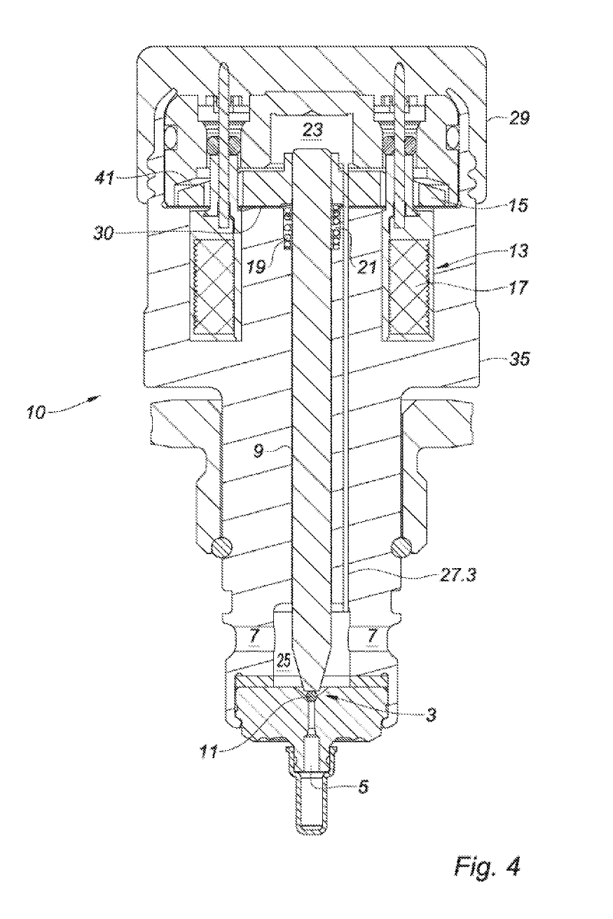

FIG. 4 is an axial section through a third variant embodiment of a pressure regulator according to the invention;

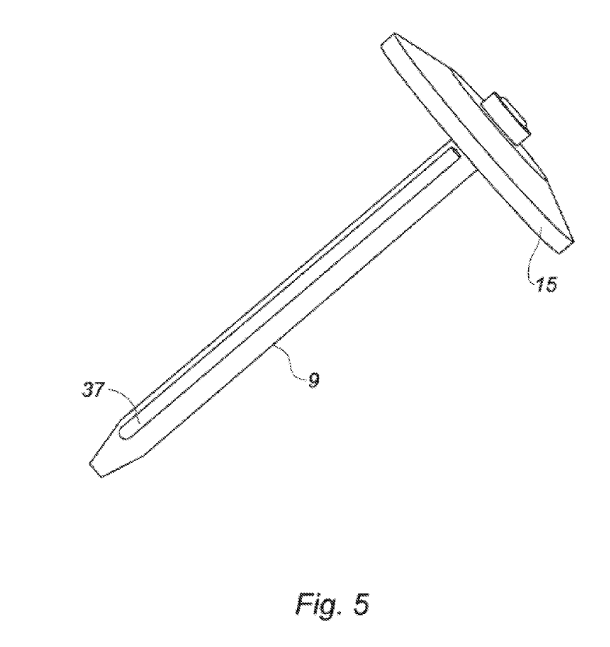

FIG. 5 is an isometric view of a rod provided with pole elements, which can be used in a pressure regulator according to the invention;

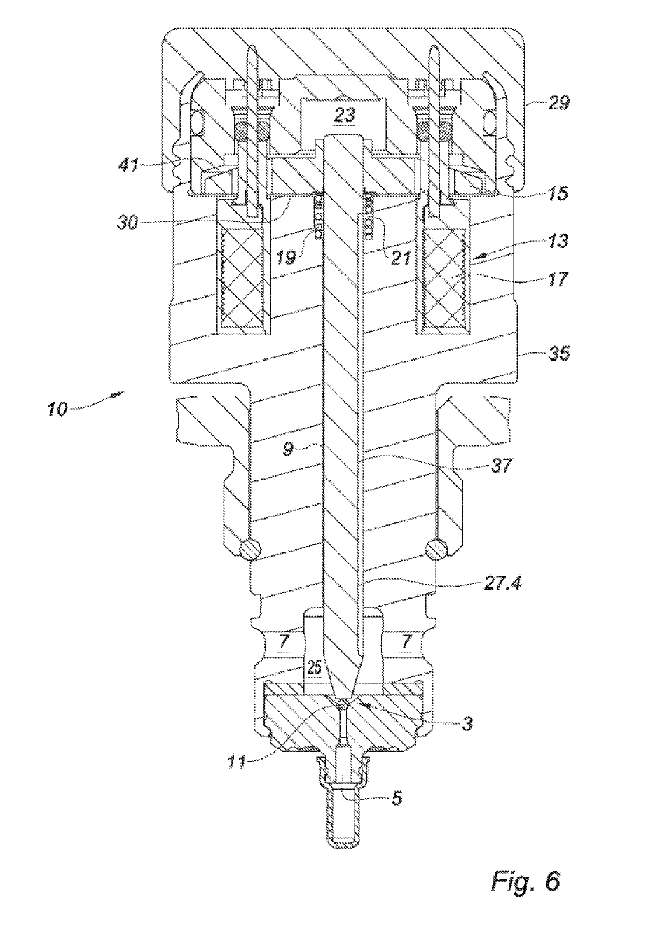

FIG. 6 is an axial section through a fourth variant embodiment of a pressure regulator according to the invention provided with a rod as shown in FIG. 5;

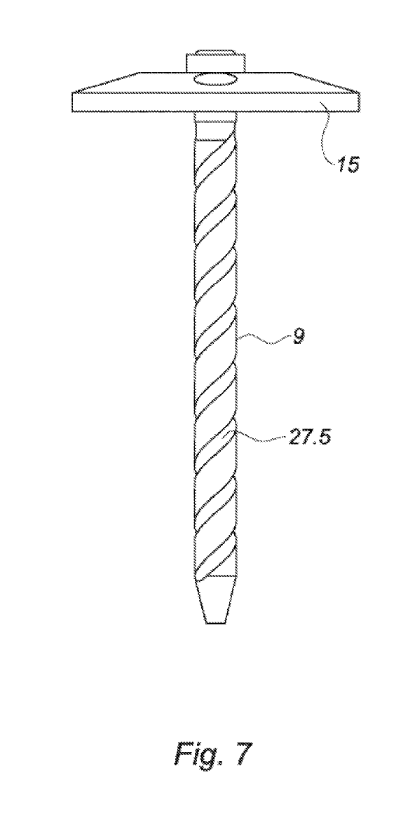

FIG. 7 is a side view of a variant embodiment of the rod provided with pole elements which could be fitted to a pressure regulator according to the invention;

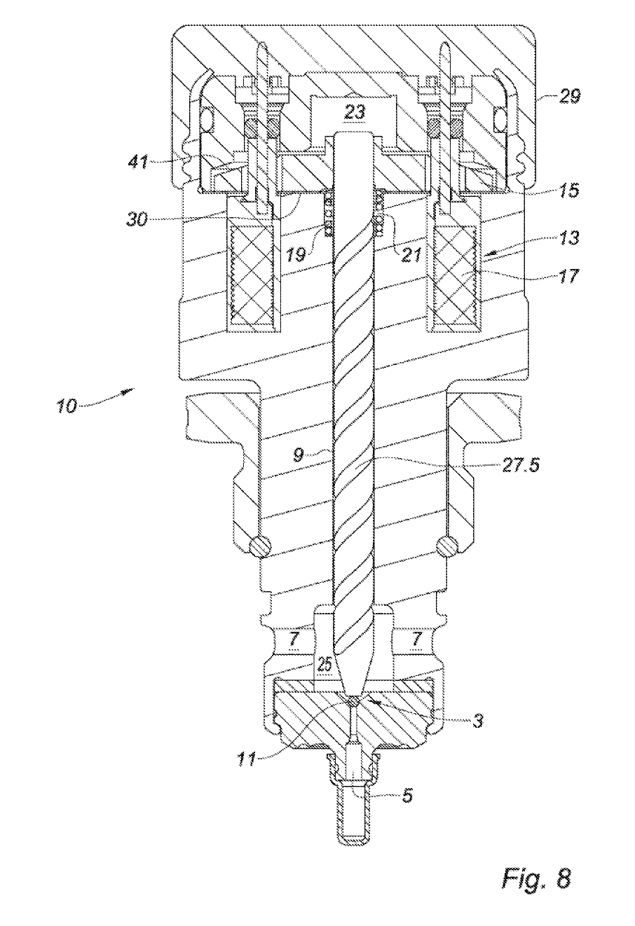

FIG. 8 is an axial section through a fifth variant embodiment of a pressure regulator according to the invention provided with a rod as shown in FIG. 7;

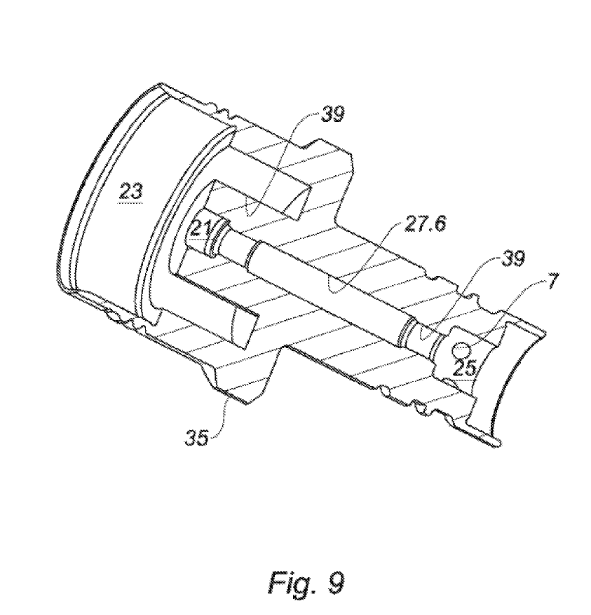

FIG. 9 is an axonometric view with a partially cut-away pressure regulator body according to the invention;

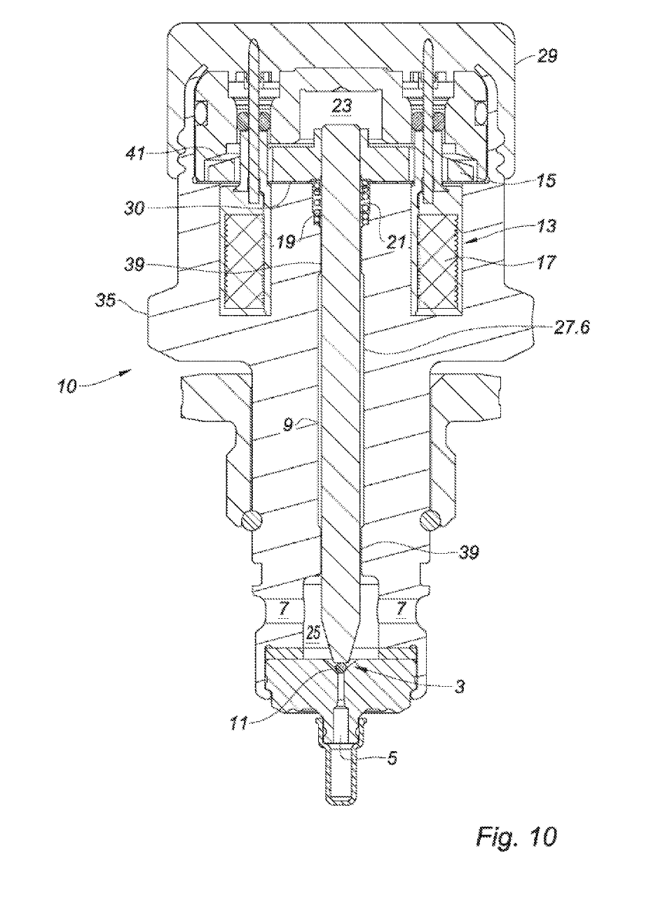

FIG. 10 is an axial section through a sixth illustrative embodiment of a pressure regulator according to the invention provided with a body as shown in FIG. 9;

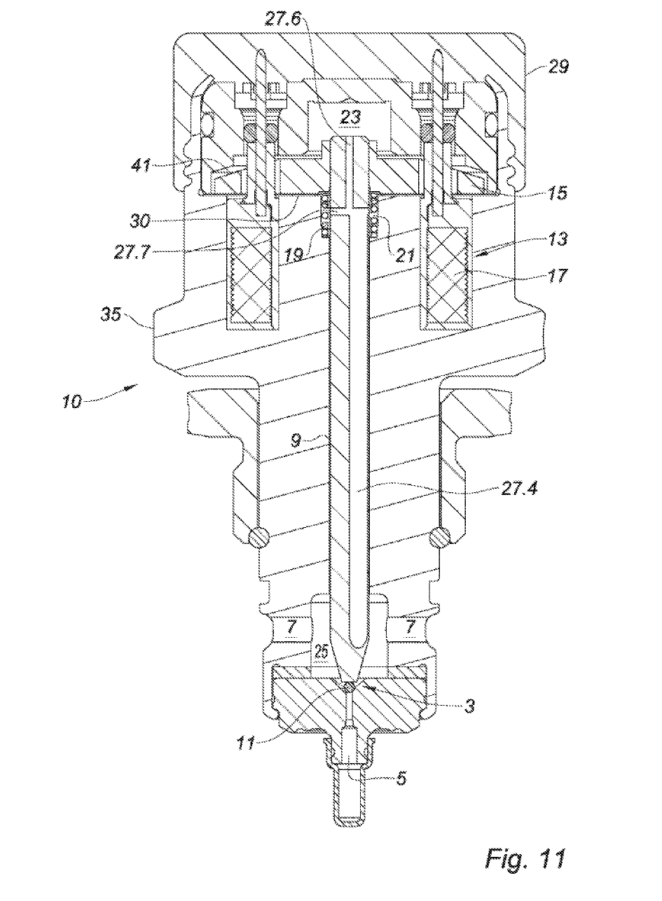

FIG. 11 is an axial section through a seventh illustrative embodiment of a pressure regulator according to the invention;

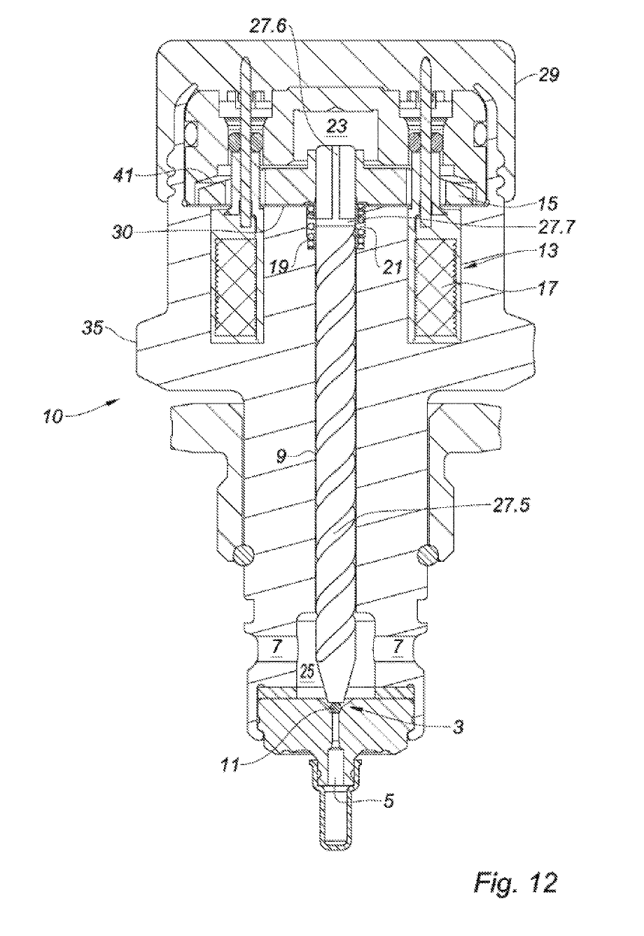

FIG. 12 is an axial section through an eighth illustrative embodiment of a pressure regulator according to the invention;

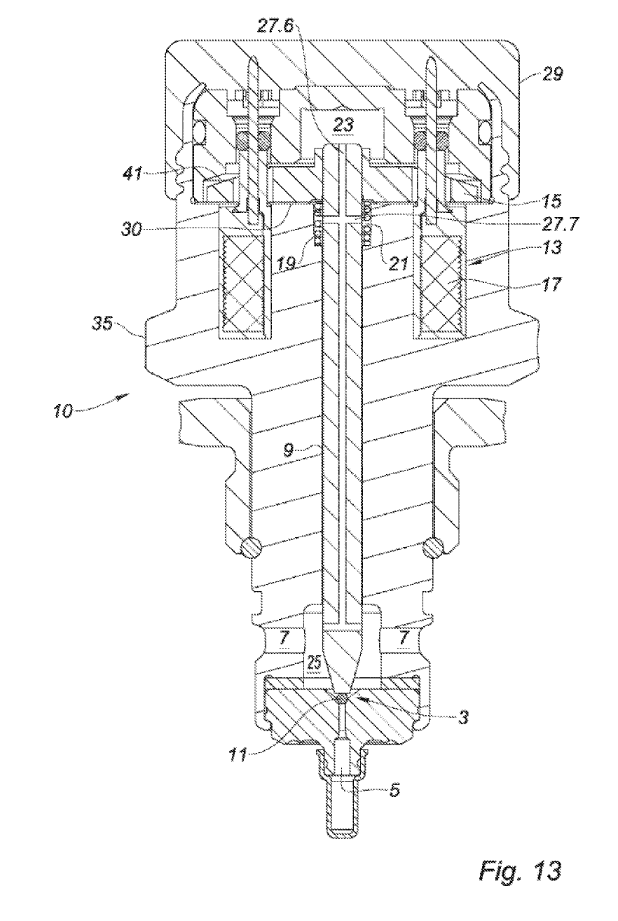

FIG. 13 is an axial section through a ninth illustrative embodiment of a pressure regulator according to the invention;

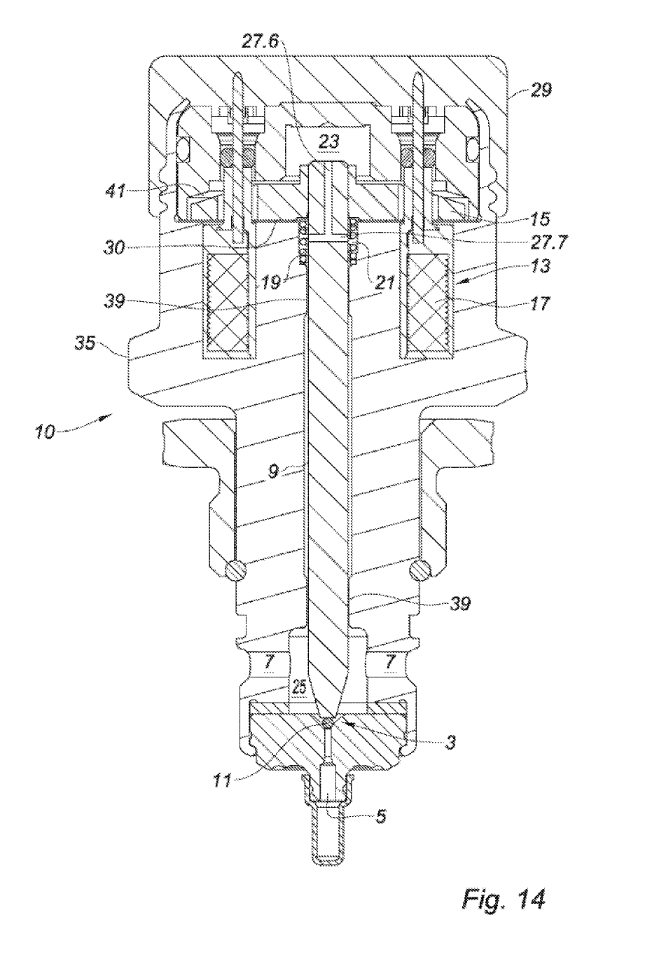

FIG. 14 is an axial section through a tenth illustrative embodiment of a pressure regulator according to the invention;

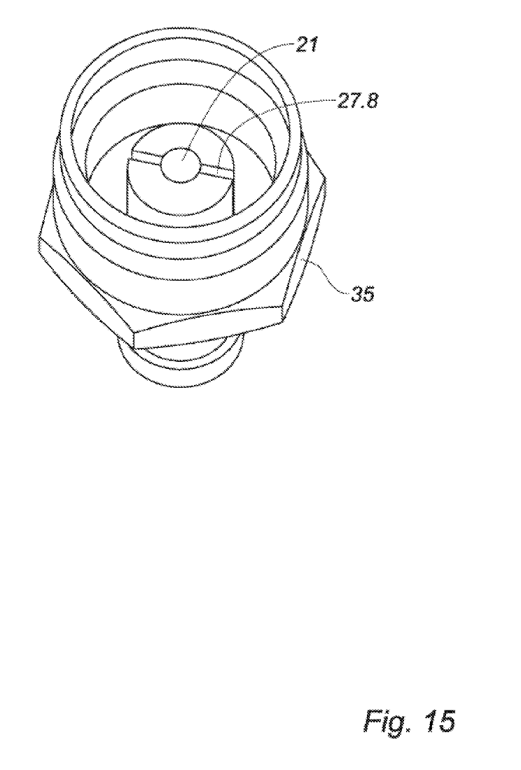

FIG. 15 is a perspective view of a body which could be installed in a pressure regulator according to the invention;

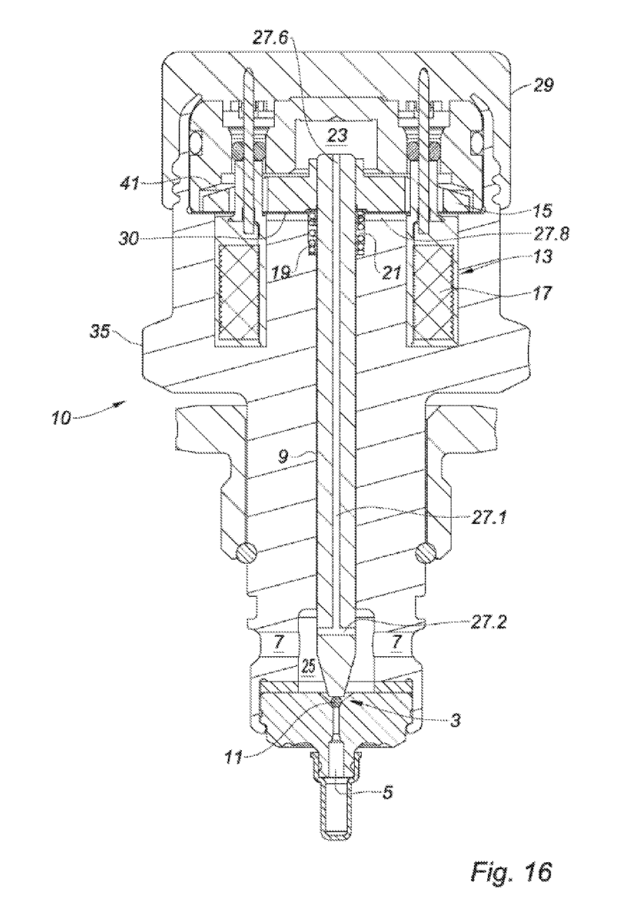

FIG. 16 is an axial section through an eleventh illustrative embodiment of a pressure regulator according to the invention provided with a body as shown in FIG. 15;

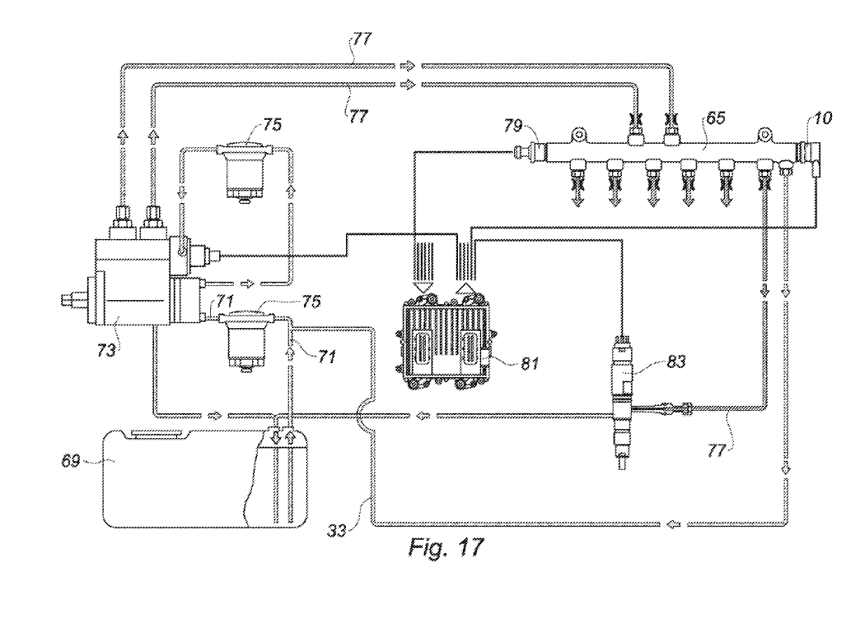

FIG. 17 is a view of a first illustrative embodiment of a diesel injection system according to the invention;

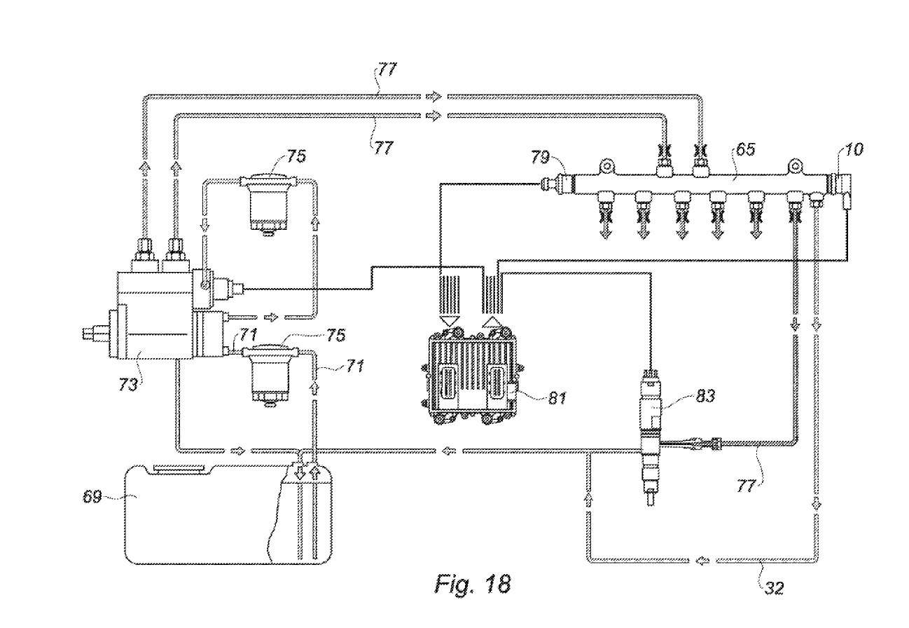

FIG. 18 is a view of a second illustrative embodiment of a diesel injection system according to the invention;

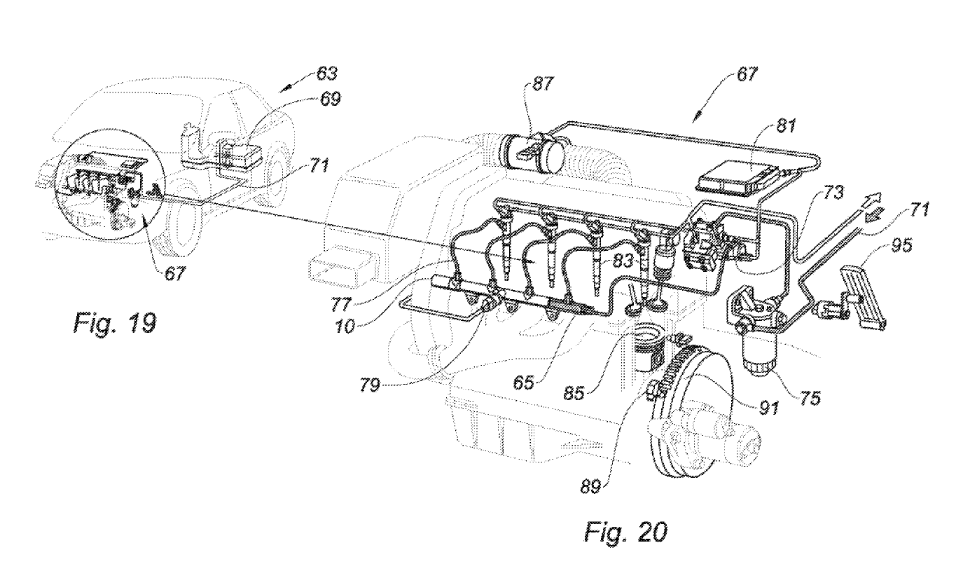

FIG. 19 is a perspective view of a motor vehicle according to the invention, partially cut away;

FIG. 20 is a perspective view of a diesel engine according to the invention for the motor vehicle in FIG. 19, partially cut away and on a larger scale;

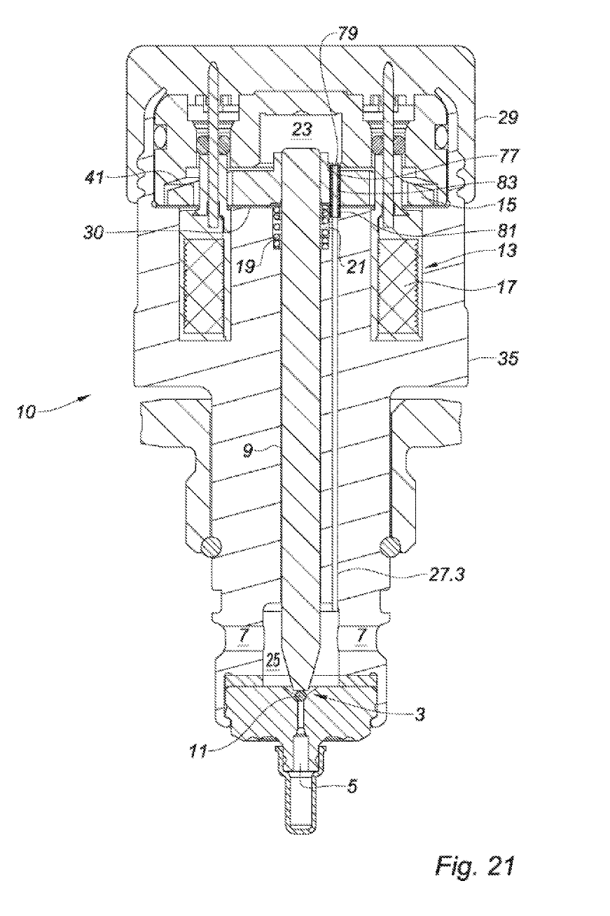

FIG. 21 is an axial section through a twelfth illustrative embodiment of a pressure regulator according to the invention;

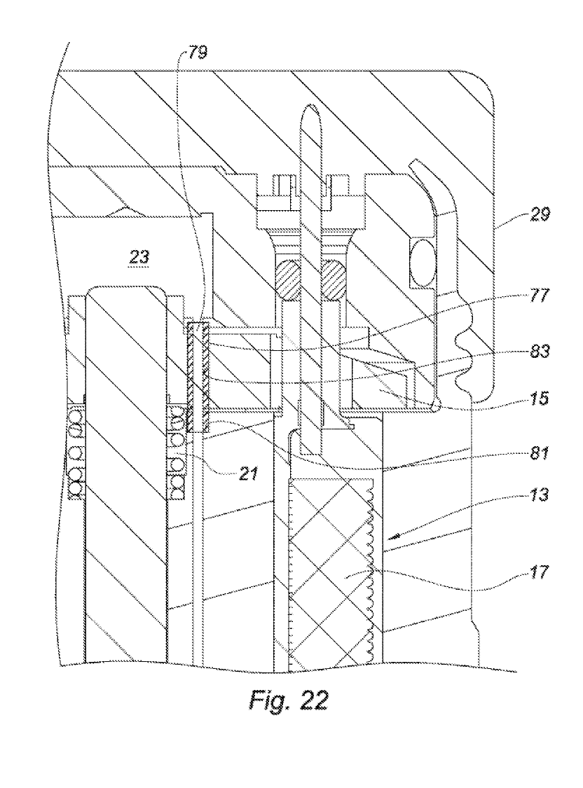

FIG. 22 is an enlarged detail of FIG. 21;

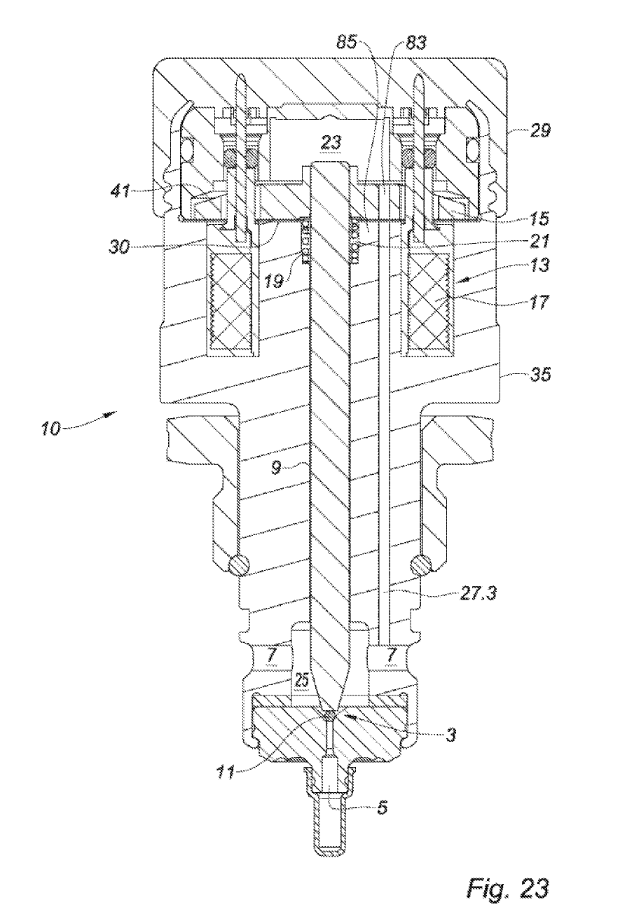

FIG. 23 is an axial section through a thirteenth illustrative embodiment of a pressure regulator according to the invention; and

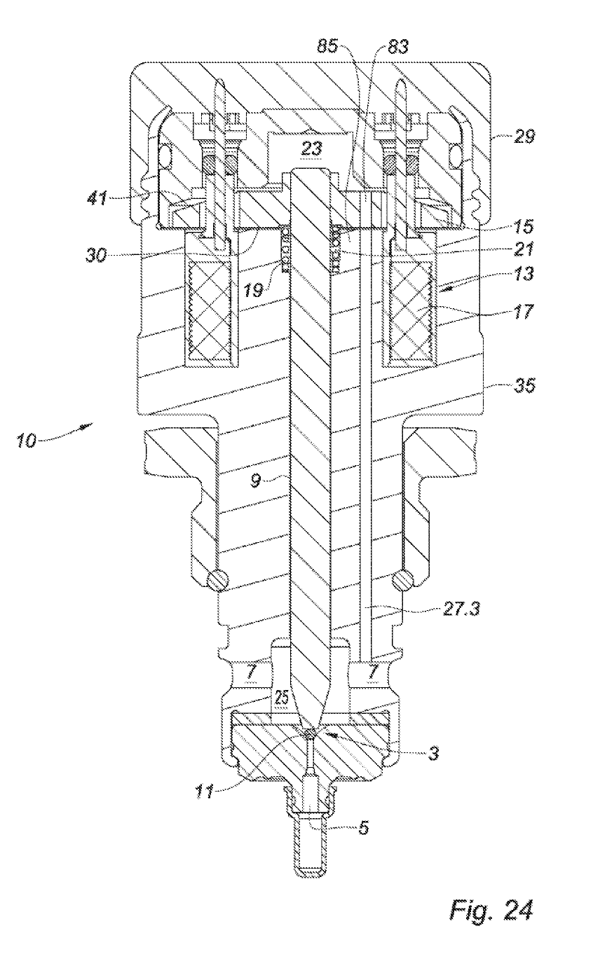

FIG. 24 is an axial section through a fourteenth illustrative embodiment of a pressure regulator according to the invention.

In FIGS. 1 to 24, the same reference numbers have been used to designate identical elements.

The pressure regulator 1 of known type has a nozzle 3, of which an inlet 5 is connected to the pressurized diesel fuel reservoir, and the low-pressure outlet ducts 7 of which could be connected to the fuel tank of the motor vehicle. On the instructions of a computer, a rod 9 ensures the closure of the nozzle 3, with a ball 11 being pressed onto a seat of the nozzle 3, for example. To drive the rod 9 in the direction of the closed position, the pressure regulator 1 has a magnetic actuator 13, which itself has a fixed magnet core with a coil 17 and has an axially movable magnet armature 15 securely connected to the rod 9, for example.

A return spring 19 pulls the rod 9 back in the direction of the open position (not shown in FIG. 1), in which the rod 9 is raised from the seat of the nozzle 3. The spring 19 is arranged in a volume referred to as a spring chamber 21, which forms a bore in alignment with the rod 9 and extends axially over a limited length. Thus, the spring 19, which is designed as a spiral spring, has a first end, which is supported on the magnet armature 15, and a second end, which is supported on a lower shoulder-forming surface of the chamber 21. In order to accommodate the rod 9, a bore with a relatively small diameter which is in alignment with the chamber 21 extends downward on the other side of the chamber 21 in the figure.

The magnet armature 15 is arranged in a chamber 23 which, depending on the current that is or is not flowing in the coil 17, allows the magnet armature 15 to adopt a first position, in which the nozzle 3 is hermetically closed, and a second position, in which the nozzle 3 is opened to a greater or lesser extent depending on the control current value in the coil 17 in order to achieve proportional control of the diesel fuel flowing back into the low-pressure circuit. The chamber 23 of the magnet armature 15 is normally extended at the axially opposite end from the nozzle 3.

In the example illustrated, the chamber 23 also has a volume 30 of the residual gap and a lift volume 41 of the armature 15.

In the pressure regulator 1, on the low-pressure side of the nozzle 3, there is a relief chamber 25, which is connected to the outlet ducts 7 leading to the diesel fuel tank or to the inlet filter of a high-pressure pump. In normal operation, the volumes of the chambers 21, 23 and 25, which do not accommodate any solid components (spring 21, rod 9 and magnet armature 15) are filled with diesel fuel, which can contain air bubbles and, at equilibrium, is at the same pressure as that in the diesel fuel supply tank of an engine fitted with a high-pressure injection system together with the pressure regulator or that in the filter arranged ahead of the high-pressure injection pump. The pressure prevailing in the diesel fuel tank is typically atmospheric pressure, while the pressure in the filter is between 0 Pa and 12×10⁵ Pa.

The applicant has discovered that the diesel fuel pressures trapped in the individual volumes, such as the relief chamber 25, the spring chamber 21, the chamber 23 of the magnetic core and the clearance between the rod 9 and the associated guide bore could produce unwanted movements of the rod. Moreover, the resultants of the pressure forces can bring about unwanted movements of the rod 9. In particular, the return flow pressure, also referred to as the relief pressure, to the fuel tank rises abruptly during starting. In this case, there is the risk that the forces acting on the ball 11 of the nozzle 3 arranged at the end of the rod 9 will cause the nozzle to reopen and hence an abrupt collapse in the pressure prevailing in the high-pressure reservoir supplying the injection valves of the engine cylinders. Indeed, the relief force and the high pressure tend to move the ball 11 upward, this tendency being reinforced by the arrangement of a spring 19 which ensures the opening of the pressure regulator if the electric power supply fails. These forces promoting the opening of the nozzle 3 can no longer be compensated for by the magnetic forces of the electric actuator 13 comprising the coil 17 and the magnet armature 15, which is designed for normal operation of the pressure regulator.

A pressure regulator 10 according to the invention of the kind illustrated in FIG. 2 differs from the pressure regulator of known type in FIG. 1 in that it has an external duct 27 connecting the relief chamber to the chamber 23 of the magnet armature 15. An upper cover 29 on the end 31 advantageously has a bore with which the duct 27 can advantageously be connected to the chamber 23 by means of a connection. The duct 27 is advantageously connected to the relief chamber 25 via the outlet ducts 7 and a connection (not shown).

The line 27 advantageously has a diesel fuel relief connection 33 leading to the fuel tank.

In the illustrative embodiment of the pressure regulator 10 according to the invention shown in FIG. 3, the relief chamber 25 is connected to the chamber 23 of the magnet armature 15 by a duct running within the rod 9.

In the advantageous example illustrated, the duct has an axial branch 27.1, which is advantageously connected to a radial branch 27.2 situated in the lower part of the rod 9 at the level of said rod where the rod projects into the relief chamber 25, both in the closed and in the open position of the nozzle 3. The axial branch 27.1 and the radial branch 27.2 of the line permanently connecting the chamber 23 of the magnet armature 15 to the relief chamber 25 are advantageously cylindrical. These branches are advantageously produced by machining—preferably by drilling. The radial bore 27.2 advantageously meets bore 27.1 without passing any further through the rod 9, thus avoiding machining burrs.

As a variant which is not shown, the rod 9 is a tube provided on the side of the nozzle 3 with a closing head. The closing head is advantageously a metal part which is connected firmly to the inside of the tube, e.g. by welding, soldering or the use of a power press and/or, if required, by lock-seaming, having a generally frustoconical shape which tapers toward the zone accommodating the ball 11.

As an alternative, the end of a cylindrical tube is plastically deformed, thereby forming a receiving and/or guiding head for the ball 11.

In the illustrative embodiment of the pressure regulator 10 shown in FIG. 4, the chamber 23 of the magnet armature 15 and the relief chamber 25 are connected by a line 27.3 machined into a body 35 of the pressure regulator 10. In the advantageous example, line 27.3 has an axis parallel to the axis of the bore accommodating the rod 9. Line 27.3 is advantageously produced by drilling.

In an advantageous variant illustrated in FIGS. 23 and 24, duct 27.3 opens into the outlet 7 connected to chamber 25. As a result, any turbulence formed as the fuel is fed in from a reservoir 65 (FIG. 18) is not transferred directly to the chamber 23 of the magnet armature. The indirect connection between chambers 25 and 23 (via the outlet 7 and line 27.3) ensures more stable operation of the pressure regulator according to the invention since the excitations caused by the pressure on the rod 9 and the magnet armature 30 are minimized.

As illustrated in FIGS. 21 and 22, a sleeve 77 provided with an axial duct 79 is advantageously arranged at an opposite end of duct 27.3 to the relief chamber 25.

As illustrated in FIGS. 21 and 22, the sleeve 77 preferably passes through an axial bore 83 machined into the magnet armature 15. Duct 79 preferably forms a butt joint with line 27.3. The outside diameter of the sleeve 77 is preferably larger than the inside diameter of line 27.3.

In the preferred example illustrated, that end of line 27.3 which faces the magnet armature 15 has a bore 81 with a larger diameter than the inside diameter of line 27.3. The inside diameter of the bore 81 is substantially the same as the outside diameter of the sleeve 77. The sleeve 77 is preferably press-fitted into the bore 81. The sleeve 77 and the axial duct 79 are preferably in alignment with line 27.3. The magnet armature 15 is provided with a precision bore 83, the inside diameter of which is slightly larger than the outside diameter of the sleeve 77. An upper part of the sleeve 77 (FIGS. 21 and 22), which projects from the body 35 of the pressure regulator 10, is accommodated in the precision bore 83 machined into the magnet armature 15. The sleeve 77 provides translatory guidance for the magnet armature 15 and/or isolation of the cage 21 of the spring 19 with respect to line 27.3. The risks of instability in pressure regulation are thereby avoided.

In the simplified variant in FIG. 24, the isolation between the chamber 21 for the spring 19 and line 27.3 is obtained by relocating line 27.3 radially toward the outside of the body 35 (in comparison with the illustrative embodiment in FIGS. 21 and 22), thus forming a partition wall 85.

The precision bore 83 which is made in the magnet armature 15 and of which one end opens into line 27.3 and the second end opens into the lift volume 41 of the core 15, advantageously has a larger diameter than the diameter of line 27.3. Thus, chamber 25 is connected to chamber 23 via the outlet 7, line 27.3, the precision bore 83 and volume 41. The variant in FIG. 24 is easier to produce since the use of a sleeve 77 is avoided.

Of course, a pressure regulator which has a sleeve 77 and line 27.3 of which opens into the outlet 7 does not exceed the scope of the present invention. In the examples illustrated, line 27.3 is parallel to the axis of the rod 9. However, the use of a sloping line 27.3 (not parallel to the axis of the rod 9) does not exceed the scope of the present invention.

FIG. 5 shows a rod 9 from which material has been removed, with the result that, after insertion into a cylindrical precision guide bore for the rod 9, a duct is formed in this precision bore which connects the spring chamber 21 to the relief chamber 25. In the example illustrated in FIG. 5, the rod 9 is provided with an axial flat 37. The length of the flat 37 advantageously suffices to ensure that duct 27.4 connects the spring chamber 21 permanently to the relief chamber 27 in any position of the rod 9 in the body 35, as illustrated, for example, in FIG. 6, in which the pressure regulator 10 according to the invention is provided with the rod 9 from FIG. 5.

It is, of course, possible for other types of duct to be introduced into the rod 9 without exceeding the scope of the present invention. In the example of the rod 9 illustrated in FIG. 7, the rod 9 is provided with a helical groove 27.5 which extends axially out of a zone occupied by the chamber 21 of the spring 19, while, at the opposite end, another part of the groove 27.5 occupies the relief chamber 25, as can be seen in FIG. 8.

FIG. 9 shows a body 35 of a pressure regulator according to the invention, which is provided with a precision bore 39 for guiding the needle and only comes into contact with said needle in zones of limited length. In the example illustrated in FIG. 9, the body 35 is provided with two guide zones 39, a first, upper zone being arranged as a direct continuation of the chamber 21 accommodating the spring 19, and a second, oppositely situated zone 39 being arranged as a direct continuation of the relief chamber 25. Between the zones 39, there is a duct 27.6 in alignment with the needle and corresponding to a bore of larger diameter. By virtue of the short axial length of the guide zones 39, pressure losses can be reduced, thus speeding up the equalization of the fuel pressure prevailing in the relief chamber 25 with the pressure in the chamber 21 for the spring 19. The pressure losses can be further reduced by making grooves in the zones 39, said grooves being axial, helical or in some other form, for example. FIG. 10 shows a pressure regulator 10 according to the invention with a body 35 of the kind illustrated in FIG. 9.

The balancing of the rod 9 is further improved by producing a duct 27 which simultaneously connects the relief chamber 25 to the chamber 21 of the spring 19 and to the chamber 23 of the magnet armature 15. In the examples of a pressure regulator 10 according to the invention shown in FIGS. 11 to 14, the duct 27 which connects the relief chamber 25 to the chamber 21 of the spring 19 is extended by a duct machined into the rod 9, of which one end opens into the chamber 21 of the spring 19 and the second end opens into the chamber 23 of the magnet armature 15. In the advantageous example illustrated, this latter duct has an axial branch 27.6, which is connected to a radial branch 27.7. The branches 27.6 and 27.7 are advantageously cylindrical. Preferably, the branches 27.6 and 27.7 are advantageously cylindrical. The branches 27.6 and 27.7 are preferably produced by drilling. Branch 27.7, like branch 27.2 in FIG. 3, has two radially opposite ends connected in the center to the axial branch.

In the example illustrated in FIG. 11, the pressure regulator 10 furthermore has a flat 37, by means of which a line 27.4 can be formed. In the example illustrated in FIG. 12, the rod 9 is provided with a line formed by an external helical groove 27.5. Figure shows a pressure regulator 10 according to the invention which is provided with a branch 27.6 arranged as an extension of an axial duct 27.1. FIG. 14 shows a pressure regulator 10 according to the invention which is provided with a body 35 that has a line 27.6 arranged in alignment with the rod 9 and a duct formed by branches 27.6 and 27.7.

Of course, the present invention is not restricted to a bore machined into the rod 9 in order to connect the chamber 21 of the spring 19 to the chamber 23 of the magnet armature 15. In an illustrative embodiment which is not shown, a duct—typically an axial bore—is introduced into the magnet armature 15.

As an alternative, as illustrated in FIG. 15, a radial duct 27.8 is machined into the pressure regulator body 35, connecting chamber 21 to the chamber for accommodating the coil, which itself is connected hydraulically to the chamber 23 of the magnet armature 15.

A pressure regulator provided with a body 35 of this kind is illustrated in FIG. 16. Of course, a body of this kind can be used instead of ducts 27.6 and 27.7 of the embodiments shown in FIGS. 11, 12, 13 and 14 without exceeding the scope of the present invention.

It is likewise an object of the present invention to indicate a high-pressure diesel injection system of the kind illustrated in FIGS. 17 and 18, an engine 67, illustrated in FIG. 19, having an injection system of this kind, and a motor vehicle 63, illustrated in FIG. 18, fitted with an injection system of this kind.

The motor vehicle 63 has a fuel tank 69 connected by a low-pressure connection 71—advantageously via a fuel filter 75—to a high-pressure pump 73. The outlet of the high-pressure pump 73 is connected to a reservoir or rail 65 by a high-pressure connection 77. It is advantageous if a pressure regulator 10 according to the invention is arranged at one end of the reservoir 65a, which is furthermore provided with a pressure pickup 79 electrically connected to an electronic computer EDC 81. The reservoir 65 is connected to a plurality of injection valves 83 (typically one per cylinder 85) by high-pressure lines 77.

It is advantageous if the engine furthermore has an air mass flow meter 87 connected to the computer 81, a speed pickup 89 for a crankshaft 91, a temperature detector 93 for the coolant to the engine 67 and a gas pedal provided with a position sensor.

The present invention is employed, in particular, in the car and truck sector. The present invention is employed, in particular, in the diesel engine industry.

### REFERENCE SIGNS

1 pressure regulator
3 nozzle
5 inlet
7 outlet
9 rod
10 pressure regulator
13 actuator
15 magnet armature
19 return spring
21 spring chamber
23 chamber of the magnetic core
25 relief chamber
27, 27.1, 27.2, 27.3, 27.4, 37, 27.5, 27.6, 27.7, 27.8 duct
30 gap volume
31 end of duct 27
32 line
33 line
35 body
37 flat
39 precision bore
41 lift volume of the core
65 reservoir
69 fuel tank
73 pump
75 filter
77 sleeve
79 duct
81 bore
83 precision bore
85 partition wall

1-11. (canceled)

12. A pressure regulator comprising:
a body;
a chamber including an inlet and an outlet, the inlet being connectable to a reservoir of a diesel fuel injection system of a diesel engine, the outlet being connectable to a low-pressure group, the outlet being connected to a relief chamber, and the chamber and the relief chamber being connected by a first line machined into the body;
a magnet armature located in the chamber;
a controllable closing device configured to be driven by an actuator between a first state and a second state, in the first state the inlet and the outlet being hermetically isolated, and in the second state the inlet being connected to the outlet;
a plurality of volumes arranged on a side of the closing device provided with the outlet; and
a pressure compensation duct configured to connect at least two volumes of the plurality of volumes to one another.

13. The pressure regulator as claimed in claim 12, wherein:
the controllable closing device includes a nozzle,
a first volume of the plurality of volumes includes the relief chamber, and
the relief chamber is arranged between the nozzle and the outlet.

14. The pressure regulator as claimed in claim 12, wherein:
the pressure compensation duct includes a second line,
the second line is situated outside the body,
a first end of the second line is connected to the outlet, and
a second end of the second line is connected to the chamber.

15. The pressure regulator as claimed in claim 12, wherein:
a sleeve including a duct is fitted,
the pressure compensation duct is passed through the sleeve,
a first end of the sleeve is connected to the line, and
a second end of the sleeve is remote from the first end of the sleeve and is configured to open into a chamber of the magnet armature.

16. The pressure regulator as claimed in claim 15, wherein:
the magnet armature defines an axial precision bore configured to accommodate the sleeve,
an end of the line opens into the outlet, and
the body includes a partition wall configured to isolate the line from a chamber of a spring.

17. The pressure regulator as claimed in claim 16, wherein:
the precision bore defines a diameter,
the diameter of the precision bore is greater than a diameter of the line, and
a first end of the precision bore opens opposite the line and a second end of the precision bore opens into a lift volume of the magnetic armature.

18. The pressure regulator as claimed in claim 12, wherein the pressure compensation duct includes a plurality of branches configured to connect three volumes of the plurality of volumes to one another.
